(19) United States
(12) Patent Application Publication
(10) Pub. No.: US 2024/0111690 A1
(43) Pub. Date: Apr. 4, 2024

(54) METHOD AND SYSTEM FOR REMAPPING ROW ADDRESS ON MULTICHANNEL DIMM

(71) Applicant: MONTAGE TECHNOLOGY CO., LTD., Shanghai (CN)

(72) Inventors: Xiaoyan LI, Shanghai (CN); Zhaohui DU, Shanghai (CN); Men LONG, Shanghai (CN); Yang CHAO, Shanghai (CN); Dajiang ZHONG, Shanghai (CN); Zhixin TIAN, Shanghai (CN)

(73) Assignee: MONTAGE TECHNOLOGY CO., LTD., Shanghai (CN)

(21) Appl. No.: 18/373,381

(22) Filed: Sep. 27, 2023

(30) Foreign Application Priority Data
Sep. 29, 2022 (CN) 202211204386.9

(51) Int. Cl. G06F 12/14; G06F 7/58

(52) U.S. Cl. CPC G06F 12/1408; G06F 7/584; G06F 12/1441

(57) ABSTRACT

This application relates to the field of memory technology, in particular to a method and a system for remapping a row address on a multichannel DIMM. The method is applied to a memory controller, comprising: receiving a first read/write access address and extracting a first channel row address from the first read/write access address; encrypting and mapping the first channel row address through a key-based mapping method to obtain a second channel row address that corresponds to the first channel row address within a predetermined address range; forming a second read/write access address based on the second channel row address and unextracted address information in the first read/write access address, and performing read/write access to the DIMM based on the second read/write access address. The present application can alleviate side channel attack without causing degradation of read/write performance.

### CROSS-REFERENCE TO PRIOR APPLICATION

This application claims priority to Chinese Application number CN202211204386.9 which is filed on Sep. 29, 2022, the contents of which are incorporated herein by reference.

### TECHNICAL FIELD

This application relates to the field of memory technology, in particular to a method and a system for remapping a row address on a multichannel DIMM.

### BACKGROUND

Two known side channel attacks are respectively the establishment of covert side channel using access conflict in a row buffer of DRAM and Row-hammer attack. The establishment of covert side channel using access conflict in DRAM's row buffer is as shown in FIG. 1, a sender and a receiver can establish a covert channel via the host side through the row buffer of the memory. For example, the receiver of a hacker (a software program running on a virtual machine in a physical machine) continuously accesses address A and measures the access time; the sender of a hacker (a software program running on another virtual machine of the same physical machine) reads/writes different row address B in the same memory bank as address A, which requires page closing and page opening operations, resulting in row access conflict. In the receiver's subsequent access to the address A, this row access conflict will increase the latency of data access. By using this difference of latency measured by the receiver, a covert channel can be established, which makes it possible to transmit illegal information. The row-hammer attack is a type of attack that damages data stored in addresses adjacent to a certain address by repeatedly accessing the certain address. With the row-hammer attack, it is possible to bypass the hardware and software protection of the memory, so that untrustworthy code can break through the limitations and take control of the entire system.

### SUMMARY OF THE INVENTION

An object of this application is to provide a method and a system for remapping a row address on a multichannel DIMM, which can alleviate side channel attack without causing degradation of read/write performance.

The application discloses a method for remapping a row address on a multichannel DIMM, applied to a memory controller, comprising:

receiving a first read/write access address and extracting a first channel row address from the first read/write access address by the memory controller;

encrypting and mapping the first channel row address through a key-based mapping method to obtain a second channel row address that corresponds to the first channel row address within a predetermined address range; and

forming a second read/write access address based on the second channel row address and unextracted address information in the first read/write access address, and performing read/write access to the DIMM based on the second read/write access address.

In one embodiment, the first channel row address and the second channel row address include a channel selection signal and a row address.

In one embodiment, the unextracted address information includes one or more of the following:

a column address, a row address, a chip selection signal for memory rank, a chip selection signal for 3D stacked chip, a memory bank address, and a rank where the memory bank is located.

In one embodiment, the key-based mapping method includes a key-based one-way derivation function.

In one embodiment, the encrypting and mapping the first channel row address through a key-based mapping method to obtain a second channel row address that corresponds to the first channel row address within a predetermined address range, further comprises:

reversing the first channel row address and performing XOR process on the reversed first channel row address with a first key to obtain a process result;

shifting the process result to obtain a shifted value; and

performing XOR process on the shifted value with a second key to obtain the second channel row address.

In one embodiment, shifting the process result includes shifting the process result through a linear feedback shift register.

In one embodiment, the method also includes:

when the memory controller is powered on, selecting a random number as initial value of the linear feedback shift register to generate a random number of predetermined bits as the first key, and selecting another random number of predetermined bits as the second key.

In one embodiment, the encrypting and mapping the first channel row address through a key-based mapping method to obtain a second channel row address that corresponds to the first channel row address within a predetermined address range, further comprises:

concatenating the first channel row address with preset characters to obtain input data that meets data length required for AES encryption operation;

performing AES encryption operation on the input data using a key; and

truncating low address portion of output of the AES encryption operation as the second channel row address.

The application discloses a system for remapping a row address on a multichannel DIMM, the system comprises a multichannel DIMM and a memory controller, the memory controller comprises:

a channel row address generator, configured to receive a first read/write access address and extract a first channel row address from the first read/write access address;

a cryptographic mapping module, configured to encrypt and map the first channel row address through a key-based mapping method to obtain a second channel row address that corresponds to the first channel row address within a predetermined address range;

an access address generator, configured to form a second read/write access address based on the second channel row address and unextracted address information in the first read/write access address and perform read/write access to the DIMM based on the second read/write access address.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a schematic diagram of a covert side channel attack established using access conflict in a row buffer of DRAM in prior art.

FIG. 2 is a flow diagram of a method for remapping a row address on a multichannel DIMM according to an embodiment of the present application.

FIG. 3 is a schematic diagram of an implementation of step 204 of a key-based one-way derivation function according to an embodiment the present application.

FIG. 4 is a schematic diagram of an example DDR5 DIMM in dual-channel mode.

FIG. 5 is a schematic diagram of an example of side channel attack.

FIG. 6 is a schematic diagram of defense of performing the row address remapping process on dual-channel DDR5 DIMM.

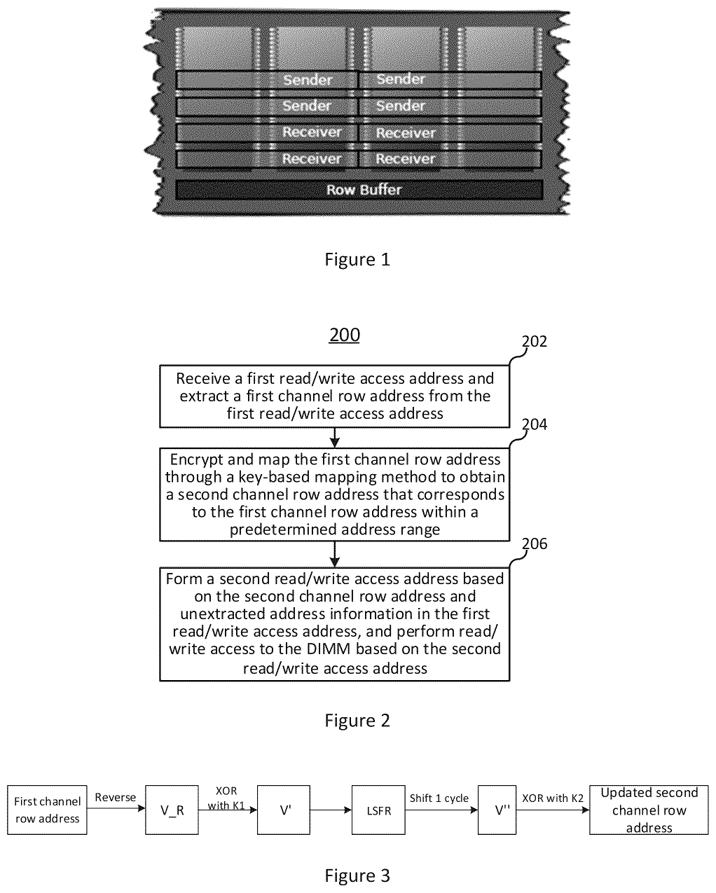

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

In order to make the objects, technical solutions and advantages of the present application clearer, embodiments of the present application will be further described in detail below with reference to the accompanying drawings.

An embodiment of the present application relates to a method 200 for remapping a row address on a multichannel DIMM, applied to a memory controller, the flow of which is shown in FIG. 2. The method 200 comprises:

Step 202, receiving a first read/write access address and extracting a first channel row address from the first read/write access address by the memory controller.

Step 204, encrypting and mapping the first channel row address through a key-based mapping method to obtain a second channel row address that corresponds to the first channel row address within a predetermined address range.

In one embodiment, the first read/write access address may include: a chip selection signal for DIMM (Dual-Inline-Memory-Modules), a chip selection signal for memory rank (bank group), a chip selection signal for 3D stacked chip, a bank address, a rank where the bank is located, a column address, and a row address. After receiving the address, the memory controller may extract the chip selection signal for the DIMM and the row address from the first read/write access address to form the first channel row address. Among them, the chip selection signal for the DIMM is a channel selection signal, and the chip selection signal for the DIMM is represented by DCH. For example, when DCH is 0, it may indicate that channel A in the DIMM is selected, and when DCH is 1, it may indicate that channel B in the DIMM is selected.

In one embodiment, the memory controller can concatenate the chip selection signal for the DIMM and the row address to form the first channel row address. The term “channel row address” in the present application may be defined as arbitrary concatenation of the channel selection signal and the row address, wherein the arbitrary concatenation may be an end-to-end concatenation, a concatenation in which one is inserted into a predetermined position in the other, or a concatenation in which one is dispersedly inserted into a predetermined plurality of positions in the other, and the present embodiments of the present application do not impose any limitation in this regard.

After receiving the first channel row address, the memory controller may encrypt and map the first channel row address through a key-based mapping method to obtain a second channel row address. In one embodiment, the key-based mapping method includes a key-based one-way derivation function. The important feature of this one-way derivation function is to ensure that there is no conflict at the output end. Taking an 18-bit channel row address as an example, there are 2¹⁸−1 different 18-bit binary numbers at input end, and there are 2¹⁸−1 different binary numbers at output end, so two different inputs will have two different outputs. In addition, the one-way derivation function also needs to meet two requirements: (1) a channel row address A should only be uniquely mapped to a channel row address B within an address range; (2) the mapped channel row address B can only be derived from the channel row address A.

In one embodiment, as shown in FIG. 3, the mapping of the first channel row address to the second channel row address through a key-based one-way derivation function may further comprise: reversing the first channel row address and performing XOR process on the reversed first channel row address with a first key to obtain a process result, shifting the process result to obtain a shifted value, and performing XOR process on the shifted value with a second key to obtain the second channel row address.

In particular, the step of shifting the process result to obtain a shifted value may include: loading the process result into a linear feedback shift register (LFSR), shifting the process result for one clock cycle and reading the value of the linear feedback shift register, which is the shifted value mentioned above. In one embodiment, an irreducible prime polynomial may be chosen as the characteristic polynomial of the linear feedback shift register. Continuing with the 18-bit channel row address as an example, a 17th degree polynomial x¹⁷+x¹⁵+x¹³+x¹¹+x⁹+x⁷+x⁵+x³+1 can be selected as the characteristic polynomial of the linear feedback shift register.

The first key and the second key may be generated for example, in following way: when the memory controller is powered on, it selects a random number as initial value of the linear feedback shift register to generate a random number with predetermined bits as the first key, and selects another random number with predetermined bits as the second key. Continuing with the 18-bit channel row address as an example, when the memory controller is powered on, a random number is selected as the initial value of the linear feedback shift register to generate a random number with 18-bit as the first key K1, and another random number with 18-bit is selected as the second key K2.

In another embodiment, the mapping of the first channel row address to the second channel row address through a key-based one-way derivation function may further comprise: concatenating the first channel row address with preset characters to obtain input data that meets the data length required for AES encryption operation; performing the AES encryption operation on the input data using a key; truncating data in low address portion of output of the AES encryption operation as the second channel row address. It should be noted that the encryption algorithm used in this embodiment is not limited to the AES encryption operation, and all encryption algorithms that can realize the encryption process of this embodiment are within the scope of protection of this application. In addition, the preset character may be 0 or 1, etc., and the embodiments of this application are not limited to this.

Step 206, forming a second read/write access address based on the second channel row address and unextracted address information in the first read/write access address received by the memory controller, and performing read/write access to the DIMM based on the second read/write address. The unextracted address information, for example, but is not limited to, includes one or more of the following: a column address, a row address, a chip selection signal for memory rank, a chip selection signal for 3D stacked chip, a memory bank address, and a rank where the memory bank is located.

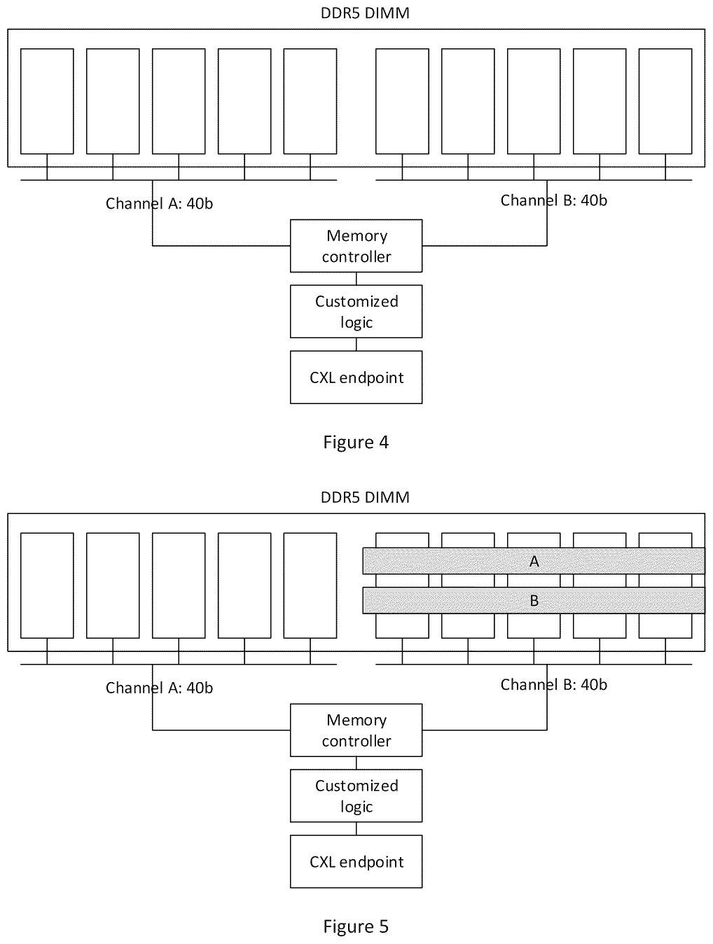

In order to better understand the technical solutions of this specification, the following is an example of the remapping process of a row address on a dual-channel DDR5 DIMM as shown in FIG. 4 and explains it in conjunction with side channel attack and defense situations. The details listed in this embodiment are mainly for ease of understanding and are not intended to limit the scope of protection of this application.

As shown in the figure, the DDR5 system includes a CXL (Compute Express Link) endpoint logic, a customized logic, a memory controller, and a DIMM. The DIMM includes dual channels, namely channel A and channel B, with each channel interface corresponding to a bit width of 40 bits (i.e., 32-bit data bit width and 8-bit ECC). The CXL endpoint logic receives a read/write request from the host and transmits it to the memory controller through the customized logic. The request includes address information, as shown in Table 1, wherein DCH is the chip selection signal for the DIMM, that is, the channel selection signal, CS is the chip selection signal for the rank, CID is the chip selection signal for the 3D stacked chip, Ba is the bank address, Bg is the rank where the bank is located, Col is the column address, and Row is the row address.

TABLE 1

| Dram | | Physical | Dram | | Physical |
|---|---|---|---|---|---|
| addr | | address | addr | | address |
| DCH | 0 | bit39 | Row | 17 | bit34 |
| CS | 1 | bit38 | Row | 16 | bit33 |
| CS | 0 | bit37 | Row | 15 | bit32 |
| CID | 1 | bit36 | Row | 14 | bit31 |
| CID | 0 | bit35 | Row | 13 | bit30 |
| Ba | 2 | bit16 | Row | 12 | bit29 |
| Ba | 1 | bit15 | Row | 11 | bit28 |
| Ba | 0 | bit14 | Row | 10 | bit27 |
| Bg | 2 | bit13 | Row | 9 | bit26 |
| Bg | 1 | bit12 | Row | 8 | bit25 |
| Bg | 0 | bit11 | Row | 7 | bit24 |
| Col | 10 | bit10 | Row | 6 | bit23 |
| Col | 9 | bit9 | Row | 5 | bit22 |
| Col | 8 | bit8 | Row | 4 | bit21 |
| Col | 7 | bit7 | Row | 3 | bit20 |
| Col | 6 | bit6 | Row | 2 | bit19 |
| Col | 5 | bit5 | Row | 1 | bit18 |
| Col | 4 | bit4 | Row | 0 | bit17 |
| Col | 3 | bit3 | | | |
| Col | 2 | 0 | | | |
| Col | 1 | 0 | | | |
| Col | 0 | 0 | | | |

The memory controller extracts DCH and Row from the address information shown in the above table, and concatenates them to obtain the first channel row address channel_row_addr=DCH∥row, where the DCH represents the channel selection signal (when DCH is 0, channel A in the DIMM is selected; when DCH is 1, channel B in the DIMM is selected), the Row represents the row address, and the ∥ represents the concatenating operation.

The mapping of the first channel row address to the second channel row address is implemented through a key-based one-way derivation function. For example, when powered on, a key K is generated in the memory controller. A second channel row address can be obtained with the key K by the following formula:

Keyed_Channel_row_addr=F_{K}(channel_row_addr),

Here F is a random permutation function. A second access address can be formed according to the second channel row address Keyed_channel_row_addr and the unextracted address information, and the DIMM can be accessed based on the second access address.

In a side channel attack, the sender and receiver of the hacker may choose different row addresses from the same memory bank to access, as shown in FIG. 5. Assuming that the first channel row addresses that the receiver and the sender want to access are A and B, respectively, wherein:

A=18′b1_0000_0000_0000_0000_0:

B=18′b1_0000_0000_0000_0000_1.

In the above channel row addresses A and B, bit[17] is 1, which means DCH is 1. Therefore, both the receiver and the sender choose to access channel B of the DIMM. However, after the address mapping of the embodiment of the present application, there is a 50% probability that the second channel row addresses A′ and B′ obtained for the receiver and the sender by the mapping is assigned to different channels, assuming that the second channel row addresses obtained after the mapping are as follows:

A′=18′b1_0100_0100_0011_0100_1

B′=18′b0_0011_1100_1000_1100_1

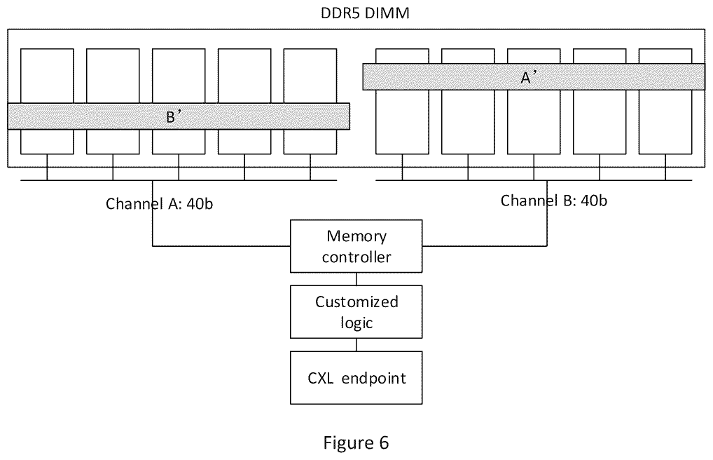

It can be seen that after address mapping, the channel to be accessed by the sender at this time has changed from the original channel B to channel A, as shown in FIG. 6, thus avoiding the row conflict (open/close the page).

An embodiment of the present application relates to a system for remapping row address on a multichannel DIMM, the system comprises a multichannel DIMM and a memory controller, the memory controller comprises a channel row address generator, a cryptographic mapping module, and an access address generator.

The channel row address generator is configured to receive a first read/write access address and extract a first channel row address from the first read/write access address.

The cryptographic mapping module is configured to encrypt and map the first channel row address through a key-based mapping method to obtain a second channel row address that corresponds to the first channel row address within a predetermined address range.

In one embodiment, the first channel row address and the second channel row address include a channel selection signal and a row address.

The key-based mapping methods are implemented in a variety of ways. In one embodiment, the key-based mapping method includes a key-based one-way derivation function. For example, the cryptographic mapping module is further configured to reverse the first channel row address and perform XOR process on the reversed first channel row address with a first key to obtain a process result, shift the process result to obtain a shifted value, and perform XOR process on the shifted value with a second key to obtain the second channel row address. Wherein the cryptographic mapping module is further configured to shift the process result through a linear feedback shift register.

In another embodiment, the key-based mapping method comprises a key-based encryption algorithm, wherein the encryption algorithm is, for example, an AES encryption algorithm. In another embodiment, the cryptographic mapping module is further configured to: concatenate the first channel row address with preset characters to obtain input data that meets the data length required for AES encryption operation; perform AES encryption operation on the input data using a key; truncate low address portion of output of the AES encryption operation as the second channel row address. In addition, the preset characters may be 0 or 1, etc., and the embodiments of this application are not limited to this.

In one embodiment, the key in this application is a key generated and protected by the memory controller during the power on process. For example, optionally, when the memory controller is powered on, it selects a random number as initial value of the linear feedback shift register to generate a random number with predetermined bits as the first key, and selects another random number with predetermined bits as the second key. In another embodiment, the keys in the present application may for example also be keys that are only hardware-knowable.

The access address generator is configured to form a second read/write access address based on the second channel row address and unextracted address information in the first read/write access address and perform read/write access to the DIMM based on the second read/write access address. Wherein the unextracted address information includes one or more of the following: a column address, a chip selection signal for memory rank, a chip selection signal for 3D stacked chip, a memory bank address, and the rank where the memory bank is located.

Embodiments of this application utilizes the multichannel feature of a single DIMM, extracts a channel row address from the accessed address information before each read/write access to the DRAM, and obtain a new channel address by cryptographically mapping the channel row address through a key-based mapping method, and form a new access address based on the new channel row address. This address processing method makes it possible for two row addresses of the same memory bank to be assigned to different channels, so that two row addresses that were originally adjacent to each other may finally in two different physical channels for the software, which mitigates the side channel attack caused by conflict in a row buffer of DRAM and the row-hammer attack to a certain extent. Moreover, this solution does not cause degradation of read/write performance of the storage module.

It will be understood that the first embodiment is a method embodiment corresponding to the present embodiment, and the technical details in the first embodiment can be applied to the present embodiment, and the technical details in the present embodiment can also be applied to the first embodiment.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises a multiple elements includes not only those elements but also other elements, or elements that are inherent to such a process, method, item, or device. Without more restrictions, the element defined by the phrase “comprise(s) a/an” does not exclude that there are other identical elements in the process, method, item or device that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

All documents mentioned in the application are considered to be included in the application of the disclosure as a whole, so that they can be used as a basis for modification when necessary. In addition, it should be understood that various changes and modifications may be made by those skilled in the art after reading the above disclosure of the present application.

In some cases, the actions or steps described in the claims can be performed in a different order than in the embodiments and still achieve desired results. In addition, the processes depicted in the drawings do not necessarily require the specific order or sequential order shown in order to achieve the desired results. In some embodiments, multitasking and parallel processing are also possible or may be advantageous.

What is claimed is:

1. A method for remapping a row address on a multichannel DIMM, applied to a memory controller, comprising:
receiving a first read/write access address and extracting a first channel row address from the first read/write access address by the memory controller;
encrypting and mapping the first channel row address through a key-based mapping method to obtain a second channel row address that corresponds to the first channel row address within a predetermined address range; and
forming a second read/write access address based on the second channel row address and unextracted address information in the first read/write access address, and performing read/write access to the DIMM based on the second read/write access address.

2. The method for remapping the row address on the multichannel DIMM of claim 1, wherein the first channel row address and the second channel row address include a channel selection signal and a row address.

3. The method for remapping the row address on the multichannel DIMM of claim 1, wherein the unextracted address information includes one or more of the following:
a column address, a chip selection signal for memory rank, a chip selection signal for 3D stacked chip, a memory bank address, and a rank where the memory bank is located.

4. The method for remapping the row address on the multichannel DIMM of claim 1, wherein the key-based mapping method includes a key-based one-way derivation function.

5. The method for remapping the row address on the multichannel DIMM of claim 4, wherein the encrypting and mapping the first channel row address through a key-based mapping method to obtain a second channel row address that corresponds to the first channel row address within a predetermined address range, further comprises:
reversing the first channel row address and performing XOR process on the reversed first channel row address with a first key to obtain a process result;
shifting the process result to obtain a shifted value; and
performing XOR process on the shifted value with a second key to obtain the second channel row address.

6. The method for remapping the row address on the multichannel DIMM of claim 5, wherein shifting the process result includes shifting the process result through a linear feedback shift register.

7. The method for remapping the row address on the multichannel DIMM of claim 5, further comprising:
when the memory controller is powered on, selecting a random number as initial value of the linear feedback shift register to generate a random number with predetermined bits as the first key, and selecting another random number with predetermined bits as the second key.

8. The method for remapping the row address on the multichannel DIMM of claim 1, wherein the encrypting and mapping the first channel row address through a key-based mapping method to obtain a second channel row address that corresponds to the first channel row address within a predetermined address range, further comprises:
concatenating the first channel row address with preset characters to obtain input data that meets data length required for AES encryption operation;
performing AES encryption operation on the input data using a key; and
truncating low address portion of output of the AES encryption operation as the second channel row address.

9. A system for remapping a row address on a multichannel DIMM, the system comprises a multichannel DIMM and a memory controller, the memory controller comprises:
a channel row address generator, configured to receive a first read/write access address and extract a first channel row address from the first read/write access address;
a cryptographic mapping module, configured to encrypt and map the first channel row address through a key-based mapping method to obtain a second channel row address that corresponds to the first channel row address within a predetermined address range; and
an access address generator, configured to form a second read/write access address based on the second channel row address and unextracted address information in the first read/write access address and perform read/write access to the DIMM based on the second read/write access address.

10. The system for remapping the row address of claim 9, wherein the first channel row address and the second channel row address include a channel selection signal and a row address.

11. The system for remapping the row address of claim 9, wherein the unextracted address information includes one or more of the following:
a column address, a row address, a chip selection signal for memory rank, a chip selection signal for 3D stacked chip, a memory bank address, and a rank where the memory bank is located.

12. The system for remapping the row address of claim 9, wherein the key-based mapping method includes a key-based one-way derivation function.

13. The system for remapping the row address of claim 12, wherein the cryptographic mapping module is further configured to reverse the first channel row address and perform XOR process on the reversed first channel row address with a first key to obtain a process result, shift the process result to obtain a shifted value, and perform XOR process on the shifted value with a second key to obtain the second channel row address.

14. The system for remapping the row address claim 13, wherein the cryptographic mapping module is further configured to shift the process result through a linear feedback shift register.

15. The system for remapping the row address claim 14, the system further comprises a key generator that, upon powered-on, selects a random number as initial value of the linear feedback shift register to generate a random number with predetermined bits as the first key, and selects another random number with predetermined bits as the second key.

16. The system for remapping the row address of claim 9, wherein the cryptographic mapping module is further configured to concatenate the first channel row address with preset characters to obtain input data that meets data length required for AES encryption operation, perform AES encryption operation on the input data using a key, and truncate low address portion of output of the AES encryption operation as the second channel row address.
